(19) United States
(12) Patent Application Publication
(10) Pub. No.: US 2020/0334490 A1
(43) Pub. Date: Oct. 22, 2020

(54) IMAGE PROCESSING APPARATUS, TRAINING METHOD AND TRAINING APPARATUS FOR THE SAME

(71) Applicant: FUJITSU LIMITED, Kawasaki-shi (JP)

(72) Inventors: Wei SHEN, Beijing (CN); Rujie LIU, Beijing (CN)

(73) Assignee: FUJITSU LIMITED, Kawasaki-shi (JP)

(21) Appl. No.: 16/745,375

(22) Filed: Jan. 17, 2020

(30) Foreign Application Priority Data
Apr. 16, 2019 (CN) 201910304695.5

(51) Int. Cl. G06K 9/62; G06N 20/00; G06F 16/56; G06K 9/46; G06F 16/532; G06F 16/587

(52) U.S. Cl. CPC G06K 9/6201; G06N 20/00; G06F 16/56; G06F 16/587; G06F 16/532; G06K 9/628; G06K 9/46

(57) ABSTRACT

The application relates to an image processing apparatus, and a training method and training apparatus for training the image processing apparatus. The training apparatus comprises: a feature map extracting unit to extract feature maps of support images and a query image; a refining unit to determine, with respect to each support image, a matching feature vector, based on the feature maps; and a joint training unit to use a training image as the query image to execute joint training, such that it is capable of determining a matching support image and a matching location with respect to a new query image, the training image matching a specific support image. The image processing apparatus trained through the above training technique is capable of simultaneously determining a matching support image among a plurality of support images respectively belonging to different classes which matches a query image, and determining a matching location.

### CROSS-REFERENCE TO RELATED APPLICATIONS

The present application claims priority to CN 201910304695.5, filed Apr. 16, 2019, the entire contents of each are incorporated herein by reference.

### FIELD OF THE INVENTION

The present disclosure relates generally to the field of information processing, and more particularly, to a training apparatus and training method for training an image processing apparatus, and an image processing apparatus trained by the training apparatus and training method.

### BACKGROUND

At present, since the collection and labeling of sample data sets need consumption of much time and calculation capacity, few-shot precise classification method such as One-short Learning method has been widely studied, such that a machine learning system is capable of quickly learning classification knowledge from a few sample data.

However, when the above-mentioned few-shot precise classification method is applied to the field of image classification, since only image level information is used for classification, a classification result obtained is only capable of indicating whether images are similar to each other, but is incapable of giving specific information on similar objects between the images. For example, assuming that both objects displayed in a support image (labeled data) and a query image (unlabeled data) are oranges, the existing image classification technique using the few-shot precise classification method is only capable of judging that the two images are similar, but is neither capable of indicating that similar objects between the two images are oranges nor capable of indicating specific locations of the similar objects between the two images, i.e., the oranges, in the images. In other words, the existing image classification technique cannot give information on an image level similarity.

To solve the above-mentioned problem, a method for applying a classifier to respective locations of a feature map of a query image has been proposed at present, thus being capable of acquiring object level information of an image and thereby performing image classification processing. However, in a case where an object in the query image does not match any object in a support image set, since the above-mentioned method lacks a classifier for the new object, a problem that classification fails may occur.

Therefore, an image processing technique is still needed, which is capable of determining a matching support image among a plurality of support images respectively belonging to different classes which matches a query image, and determining a matching location of the query image with the matching support image. Further, the image processing technique is capable of handling a case where the query image does not match any support image.

### SUMMARY OF THE INVENTION

To solve the problem existing in the prior art, the present disclosure proposes a novel training technique for training an image processing apparatus. The training technique determines a matching feature vector representing a matching degree and a matching location between a support image and a query image by extracting feature maps of the support mage and the query image, and uses a training image which matches a specific support image as the query image to train the image processing apparatus based on the matching feature vector.

A brief summary of the present disclosure will be given below to provide a basic understanding of some aspects of the present disclosure. It should be understood that the summary is not an exhaustive summary of the present disclosure. It does not intend to define a key or important part of the present disclosure, nor does it intend to limit the scope of the present disclosure. The object of the summary is only to briefly present some concepts, which serves as a preamble of the detailed description that follows.

One of the objects of the present disclosure lies in providing a training apparatus and training method for an image processing apparatus. An image processing apparatus trained by the training apparatus and training method according to the present disclosure is capable of determining a matching support image among a plurality of support images respectively belonging to different classes which matches a query image, and determining a matching location of the query image with the matching support image. Further, the image processing apparatus trained through the training technique is capable of handling a case where the query image does not match any support image.

To achieve the object of the present disclosure, according to an aspect of the present disclosure, there is provided a training apparatus for training an image processing apparatus. The image processing apparatus is used for determining a matching support image among a plurality of support images respectively belonging to different classes which matches a query image and for determining a matching location of the query image with the matching support image. The training apparatus may include: a feature map extracting unit which extracts a feature map of each of the plurality of support images and a feature map of the query image; a refining unit which determines, with respect to each support image, a matching feature vector representing a matching degree and a matching location between the support image and the query image, through N times of iterative calculations, based on the feature maps of the support image and the query image, where N is a natural number not less than 2; and a joint training unit which uses each of a plurality of training images as the query image to execute joint training on parameters of the feature map extracting unit and parameters of the refining unit based on the matching feature vector, such that the image processing apparatus is capable of determining the matching support image and the matching location with respect to a new query image, wherein each of the plurality of training images matches a specific support image among the plurality of support images.

According to another aspect of the present disclosure, there is provided a training method for training an image processing apparatus. The image processing apparatus is used for determining a matching support image among a plurality of support images respectively belonging to different classes which matches a query image and for determining a matching location of the query image with the matching support image. The training method includes: extracting a feature map of each of the plurality of support images and a feature map of the query image; determining, with respect to each support image, a matching feature vector representing a matching degree and a matching location between the support image and the query image, through N times of iterative calculations, based on the feature maps of the support image and the query image, where N is a natural number not less than 2; and using each of a plurality of training images as the query image to execute joint training on parameters used in the step of extracting the feature map and parameters of used in the step of determining the matching feature vector based on the matching feature vector, such that the image processing apparatus is capable of determining the matching support image and the matching location with respect to a new query image, wherein each of the plurality of training images matches a specific support image among the plurality of support images.

According to still another aspect of the present disclosure, there is provided an image processing apparatus, for determining a matching support image among a plurality of support images respectively belonging to different classes which matches a query image and for determining a matching location of the query image with the matching support image. The image processing apparatus may include the feature map extracting unit and the refining unit of the training apparatus according to the above-mentioned aspect of the present disclosure, and a convolutional unit.

According to yet another aspect of the present disclosure, there is provided a computer program capable of implementing the above-mentioned training method. Further, there is also provided a computer program product in at least computer readable medium form, which has recorded thereon a computer program code for implementing the above-mentioned training method.

The image processing apparatus trained through the technique according to the present disclosure is capable of determining a matching support image among a plurality of support images respectively belonging to different classes which matches a query image, and determining a matching location of the query image with the matching support image. Further, the image processing apparatus trained through the training technique is capable of handling the case where the query image does not match any support image.

### BRIEF DESCRIPTION OF THE DRAWINGS

The above and other objects, features and advantages of the present disclosure would be more easily understood with reference to the following description of embodiments of the present disclosure combined with the appended drawings. In the appended drawings:

FIG. 1 shows a block diagram of a training apparatus for training an image processing apparatus according to an embodiment of the present disclosure;

FIG. 2 shows a block diagram of a refining unit according to the embodiment of the present disclosure;

FIG. 3 shows a schematic view of the refining unit according to the embodiment of the present disclosure;

FIG. 4A shows a schematic view of processing performed by a feature vector extracting sub-unit in a first time of iterative calculation;

FIG. 4B shows a schematic view of processing performed by the feature vector extracting sub-unit in an n-th time of iterative calculation;

FIG. 5A shows a schematic view of a typical LSTM unit;

FIG. 5B shows a schematic view of a simplified LSTM unit according to an embodiment of the present disclosure;

FIG. 6 shows a block diagram of an image processing apparatus according to an embodiment of the present disclosure;

FIG. 7 shows a schematic view of a processing example of the image processing apparatus according to the embodiment of the present disclosure;

FIG. 8 shows a flowchart of a training method for training an image processing apparatus according to an embodiment of the present disclosure; and

FIG. 9 shows a structure diagram of a general-purpose machine that can be used to realize the training apparatus and training method according to the embodiments of the present disclosure.

### DETAILED DESCRIPTION OF THE INVENTION

Hereinafter, some embodiments of the present disclosure will be described in detail with reference to the appended illustrative figures. In denoting elements in the figures with reference signs, although identical elements are shown in different figures, identical elements will be denoted by identical reference signs. Further, in the following description of the present disclosure, detailed description of known functions and configurations incorporated herein will be omitted while possibly making the subject matter of the present disclosure unclear.

The terms used herein are used only for the purpose of describing specific embodiments, but are not intended to limit the present disclosure. The singular forms used herein are intended to also include plural forms, unless otherwise indicated in the context. It will also be understood that, the terms “comprise”, “include” and “have” used in the specification are intended to specifically indicate presence of features, entities, operations and/or components as stated, but do not preclude presence or addition of one or more other features, entities, operations and/or components.

All the terms including technical terms and scientific terms used herein have same meanings as those are generally understood by those skilled in the field to which the concept of the present invention pertains, unless otherwise defined. It will be further understood that, terms such as those defined in a general dictionary should be construed as having meanings consistent with those in the context of the relevant field and, unless explicitly defined herein, should not be interpreted with ideal or quite formal meanings.

In the description that follows, many specific details are stated to provide comprehensive understanding to the present disclosure. The present disclosure could be implemented without some or all of these specific details. In other examples, to avoid the present disclosure from being obscured due to unnecessary details, only those components closely related to the solution according to the present disclosure are shown in the drawings, while omitting other details not closely related to the present disclosure.

Hereinafter, terms “support image” and “training image” refer to image data with a label, that is, the class of an object displayed in the image is known, wherein the support image may represent a representative image in an image set which displays a specific object, i.e., an image set of a specific class, and the training image may represent any image in an image set which displays a specific object.

In the embodiments described below, to facilitate description, for each class of a plurality of classes of images, only one image among the images of the class is selected for use as a support image which represents a representative image of the class. However, those skilled in the art should appreciate that, each class of image data set may have one or more support images.

Hereinafter, term “query image” refers to image data without a label, that is, the class of an object displayed in the image is unknown. The object of the present disclosure lies in providing a training technique for training an information processing apparatus. The image processing apparatus trained through the training technique is capable of determining which support image matches the query image, i.e., determining a matching support image, and determining a location of an object corresponding to a class to which the matching support image belongs in the query image.

The core concept of the technique of the present disclosure lies in obtaining a matching feature vector representing a matching degree and a matching location between a support image and a query image by utilizing feature maps reflecting high order features of the support image and the query image, from the matching feature vector, a support image which matches the query image, i.e., a class of the query image can be determined, and meanwhile locations of an object corresponding to the class in the query image and the support image can be determined.

Hereinafter, a training apparatus and training method for training an image processing apparatus according to each embodiment of the present disclosure will be described in detail with reference to the drawings.

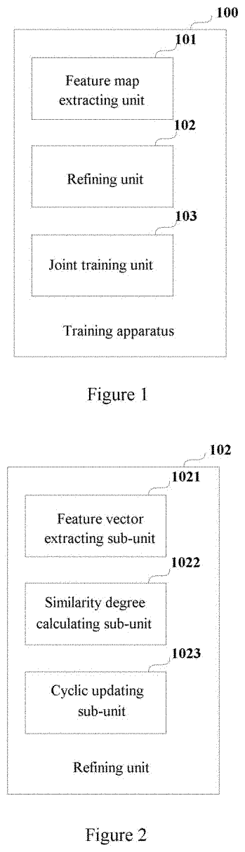

FIG. 1 shows a block diagram of a training apparatus 100 for training an image processing apparatus according to an embodiment of the present disclosure.

As shown in FIG. 1, the training apparatus 100 may include a feature map extracting unit 101, a refining unit 102, and a joint training unit 103.

According to the embodiment of the present disclosure, the feature map extracting unit 101 may extract a feature map of each of a plurality of support images and a feature map of a query image, and may provide the obtained feature maps to the refining unit 102.

In some embodiments, the feature map extracting unit 101 may be realized through a convolutional neural network (CNN).

The CNN is a feedforward artificial neural network, which is widely applied to the field of image and speech processing. The CNN is based on three important features, i.e., receptive field, weight sharing, and pooling.

The CNN assumes that each neuron only has a connection relationship with neurons in a neighboring area and produces an influence upon each other. The receptive field represents a size of the neighboring area. Further, the CNN assumes that a connection weight between neurons in a certain area may also be applied to other areas, i.e., weight sharing. The pooling of the CNN refers to a dimension reduction operation performed based on aggregation statistics when using the CNN to solve a classification problem.

Accordingly, the CNN is composed of an input layer, an output layer, and a plurality of hidden layers therebetween. The hidden layer may include a convolutional layer, a pooling layer, an activation layer, and a full-connect layer. At each convolutional layer, image data exist in three-dimensional form, which may be regarded as a lamination of a plurality of two-dimensional images, i.e., a feature map. The feature map reflects high order features of an input image. Generally, to retain enough features of the input image, a size of each layer of feature map is not less than 5×5.

Through the processing by the CNN, a feature map of each of the plurality of support images and a feature map of the query image can be obtained.

The processing of extracting a feature map of an image by the CNN is a technique known to those skilled in the art; thus, for the sake of conciseness, no further description of technical details thereof is made herein.

According to the embodiment of the present disclosure, the refining unit 102 may determine, with respect to each support image, a matching feature vector representing a matching degree and a matching location between the support image and the query image, through N times of iterative calculations, based on the feature maps of the support image and the query image which are provided by the feature map extracting unit 101, where N is a natural number not less than 2. FIG. 2 shows a block diagram of the refining unit 102 according to the embodiment of the present disclosure.

In some embodiments, as shown in FIG. 2, the refining unit 102 may include a feature vector extracting sub-unit 1021, a similarity degree calculating sub-unit 1022, and a cyclic updating sub-unit 1023.

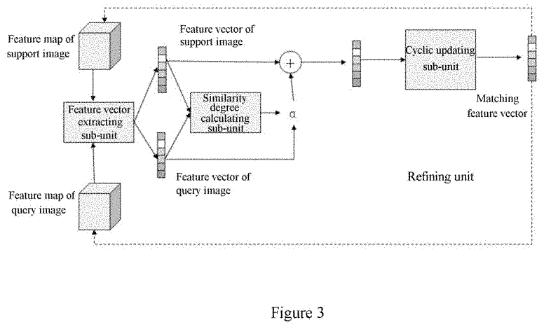

FIG. 3 shows a schematic view of the refining unit 102 according to the embodiment of the present disclosure.

In some embodiments, the feature vector extracting sub-unit 1021 may extract feature vectors of the support image and the query image based on the feature maps of the support image and the query image. The similarity degree calculating sub-unit 1022 may calculate a similarity degree between the feature vector of the support image and the feature vector of the query image. The cyclic updating sub-unit 1023 may calculate the matching feature vector based on the feature vectors of the support image and the query image and the similarity degree.

In some embodiments, as shown in FIG. 3, in the refining unit 102, the feature vector extracting sub-unit 1021 may generate, based on the feature maps of the support image and the query image which are provided from the feature map extracting unit 101 and a previous matching feature vector as a result of a previous time of iterative calculation which is fed back from the cyclic updating sub-unit 1023, a feature vector of the support image and a feature vector of the query image.

For example, the feature vector of the support image may be represented by fs, and the feature vector of the query image may be represented by fq.

In some embodiments, for a first iterative calculation among N times of iterative calculation, due to the absence of a result of a previous time of iterative calculation, the feature vector extracting sub-unit 1021 extracts the feature vectors fs₁ and fp₁ of the support image and the query image through global average pooling based only on the feature map of the support image and the feature map of the query image.

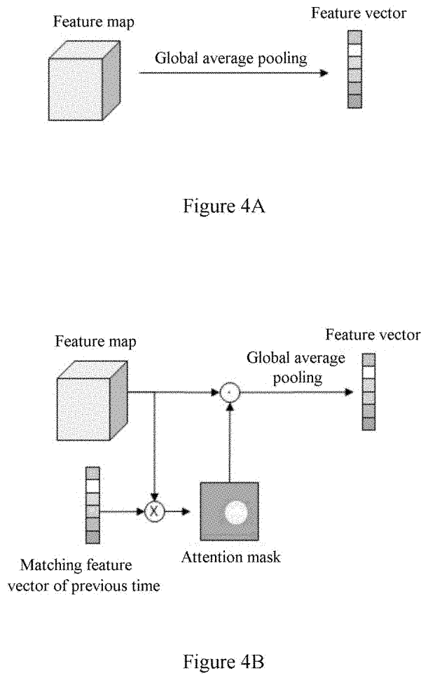

FIG. 4A shows a schematic view of processing performed by the feature vector extracting sub-unit 1021 in the first time of iterative calculation. As shown in FIG. 4A, a feature map in three-dimensional form may be dimension-reduced to a corresponding feature vector by performing global average pooling in the pooling layer of the CNN. The pooling processing in the CNN is a technique known to those skilled in the art; thus, for the sake of conciseness, no further description of technical details thereof is made herein.

In some embodiments, for an n-th time of iterative calculation among N times of iterative calculation, where n is a natural number greater than 1 and less than or equal to N, the feature vector extracting sub-unit 1021 may extract the feature vectors fsₙ and fpₙ of the support image and the query image through global average pooling based on the feature maps of the support image and the query image and a matching feature vector obtained through an (n−1)-th time of iterative calculation.

FIG. 4B shows a schematic view of processing performed by the feature vector extracting sub-unit in the n-th time of iterative calculation.

As shown in FIG. 4B, a result of a previous time of iterative calculation by the refining unit 102, i.e., the matching feature vector, may be represented by fmₙ₋₁. According to the embodiment of the present disclosure, taking the feature map of the support image as an example, in a current iterative period, the feature vector extracting sub-unit 1021 performs a convolution operation of the matching feature vector fmₙ₋₁ as a result of the previous time of iterative calculation and the feature map of the support image, and a result obtained thereby may be called an attention mask. The attention mask may be physically understood as representing an area where a specific object in the support image lies, which is represented by a highlighted area in the schematic view of FIG. 4B.

Subsequently, the feature vector extracting sub-unit 1021 performs a point multiplication operation of the obtained attention mask and the feature map of the support image and performs global average pooling processing, thereby the feature vector fs of the support mage can be obtained.

The processing described above with reference to FIG. 4B by taking the feature map of the support image as an example is also applied to the query image, to obtain the feature vector fq of the query image.

As shown in FIG. 3, the feature vector extracting sub-unit 1021 inputs the obtained feature vector fs of the support image and feature vector fq of the query image to the similarity degree calculating sub-unit 1022, which calculates the similarity degree a between the feature vector fs of the support image and the feature vector fq of the query image.

The similarity degree between the feature vector fs and the feature vector fq can be calculated in various manners. In some embodiments, the similarity degree calculating sub-unit 1022 may be realized through a multi-layer perceptron (MLP) as a multi-layer fully connected neural network model. The processing of calculating a similarity degree between two vectors by the MLP is a technique known to those skilled in the art; thus, for the sake of conciseness, no further description of technical details thereof is made herein.

As stated above, the cyclic updating sub-unit 1023 may calculate the matching feature vector w by use of the similarity degree a between the feature vector fs of the support image and the feature vector fq of the query image which is calculated by the similarity degree calculating sub-unit 1022 as well as the feature vector fs of the support image and the feature vector fq of the query image.

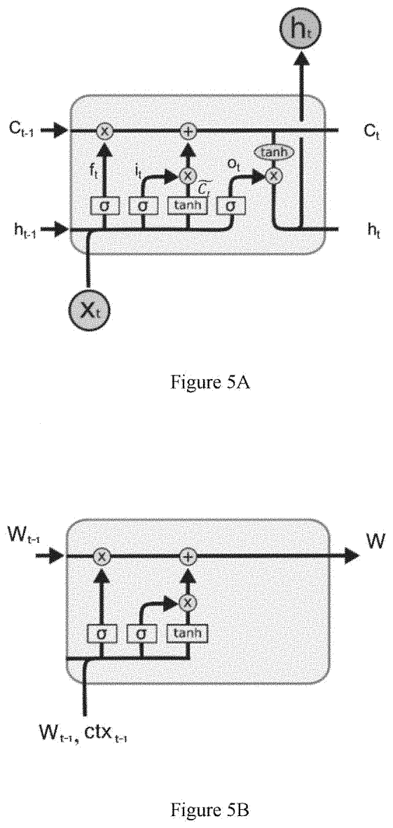

Specifically, in some embodiments, the cyclic updating sub-unit 1023 may be realized through a simplified long short-term memory model (LSTM) of an outgate operation. FIG. 5A shows a schematic view of a typical LSTM unit, and FIG. 5B shows a schematic view of a simplified LSTM unit according to an embodiment of the present disclosure.

The LSTM model is capable of learning a dependency in a long time range by its memory unit, and it generally includes four units, i.e., an input gate iₜ, an output gate oₜ, a forget gate fₜ, and a storage state Cₜ, wherein t represents a current time step. The storage state Cₜ influences current states of other units according to a state of a previous time step. The forget gate fₜ may be used for determining which information should be abandoned. The above process may be represented by the following equations

fₜ=σ(W_{f}·[hₜ₋₁, xₜ]+b_{f})

iₜ=σ(Wᵢ·[hₜ₋₁, xₜ]+bᵢ)

\tilde{C}ₜ=tan h(W_{C}·[hₜ₋₁, xₜ]+b_{C})

oₜ=σ(Wₒ[hₜ₋₁, xₜ]+bₒ)

hₜ=oₜ*tan h(\tilde{C}ₜ)

Cₜ=fₜ*Cₜ₋₁+iₜ*Cₜ

Where σ is a sigmoid function, xₜ represents an input of the current time step t, hₜ represents an intermediate state of the current time step t, and oₜ represents an output of the current time step t. Connection weight matrixes W_{f},Wᵢ, W_{C}, Wₒ and biasing vectors bᵢ, b_{f}, b_{C}, bₒ are parameters to be trained.

When the above LSTM is used to realize the cyclic updating sub-unit 1023, as shown in FIG. 5B, in the simplified LSTM unit used according to the embodiment of the present disclosure, calculation of the intermediate state hₜ is omitted. As such, only a vector Cₜ₋₁ of a previous time step t−1 and the input vector xₜ are inputted at an input end of the simplified LSTM unit. To facilitate understanding, in FIG. 5B, C is replaced with reference sign w.

The input vector xₜ=[wₜ₋₁,ctxₜ₋₁], which represents a vector obtained by splicing the vector wₜ₋₁ of the previous time step and a vector ctxₜ₋₁ together.

As shown in FIG. 5B, according to the embodiment of the present disclosure, the vector wₜ₋₁=fs+afq, where a is the similarity degree calculated by the similarity degree calculating sub-unit 1022, and a smaller value of α represents a smaller similarity degree between the feature vector fs and the feature vector fq. A current output wₜ of the simplified LSTM unit used according to the embodiment of the present disclosure may be understood as a currently calculated matching feature vector, which may represent whether there is a display object identical to the support image in the query image, and a location of the object. The wₜ vector may be physically understood as a weight of each classifier corresponding to support image respectively.

Further, according to the embodiment of the present disclosure, vector ctxⁱ=Σⱼb^{ij}wⁱ, wherein bᵢⱼ=(wⁱ)^{T}w^{j}, wherein b^{ij} may be physically understood as a relationship between each weight in the vector w and other weights.

In some embodiments, for a first iterative calculation among N times of iterative calculation, due to the absence of a result of a previous time of iterative calculation, the cyclic updating sub-unit 1023 calculates the matching feature vector based only on the feature vectors of the support image and the query image which are extracted by the feature vector extracting sub-unit 1021 and the similarity degree calculated by the similarity degree calculating sub-unit 1022. For an n-th time of iterative calculation among N times of iterative calculation, where n is a natural number greater than 1 and less than or equal to N, the cyclic updating sub-unit 1023 calculates the current matching feature vector using the feature maps of the support image and the query image which are extracted by the feature vector extracting sub-unit 1021 based on a matching feature vector obtained through the (n−1)-th time of iterative calculation, the similarity degree calculated by the similarity degree calculating sub-unit 1022 and the matching feature vector obtained through the (n−1)-th time of iterative calculation.

In some embodiments, the iteration number N of the refining unit 102 may be determined according to experience, and may also be determined according to specific application environments. Generally, N is not less than 2.

As stated above, the joint training unit 103 may use each of a plurality of training images as the query image to execute joint training on parameters of the feature map extracting unit and parameters of the refining unit based on the matching feature vector, wherein each of the plurality of training images matches a specific support image among the plurality of support images.

In some embodiments, the joint training unit 103 may perform joint training on parameters of the CNN which realizes the feature map extracting unit 101, the MLP which realizes the similarity degree calculating sub-unit 1022 and the simplified LSTM which realizes the cyclic updating sub-unit 1023. The object of the joint training lies in making a softmax classification error between the matching feature vector and the feature vector of the query image minimum. It is possible to construct a loss function of the training apparatus 100 by various methods, and thereby to perform joint training by gradient descent method using training images. The technique of performing joint training by gradient descent method is known in the art, and thus no further description of technical details thereof is made herein.

Accordingly, the present disclosure further proposes an image processing apparatus, which is trained by the above-mentioned training apparatus 100.

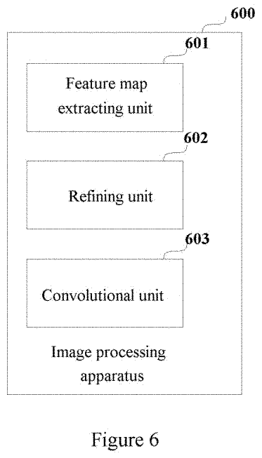

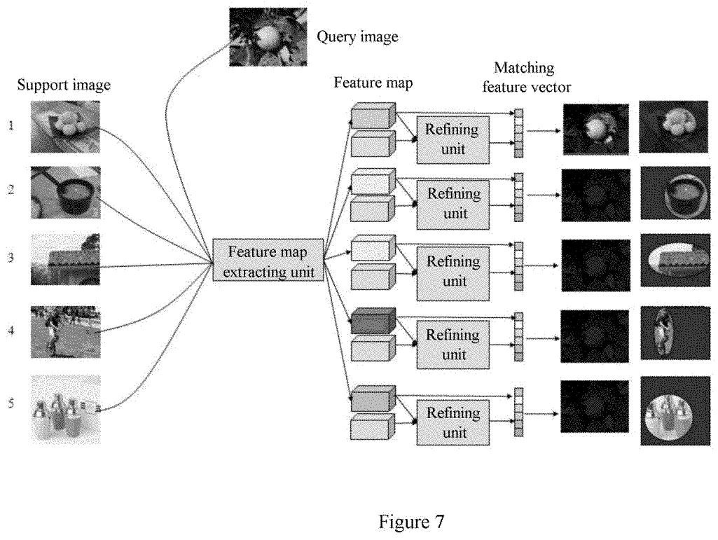

FIG. 6 shows a block diagram of an image processing apparatus 600 according to an embodiment of the present disclosure, and FIG. 7 shows a schematic view of a processing example of the image processing apparatus 600 according to the embodiment of the present disclosure.

As shown in FIG. 6, the image processing apparatus 600 may include a feature map extracting unit 601, a refining unit 602, and a convolutional unit 603. The feature map extracting unit 601 may have the same structure as the feature map extracting unit 101 described above and is trained by the training apparatus 100 described above. Further, the refining unit 602 may have the same structure as the refining unit 601 described above and is trained by the training apparatus 100 described above.

For example, as shown in FIG. 7, it is assumed that there are image data sets of five classes, in which displayed objects are different, and the image data sets of the five classes have support images serving as respective representative images respectively.

In a case of inputting a query image without a label to the image processing apparatus 600, the feature map extracting unit 601 of the image processing apparatus 600 extracts a feature map of the query image and feature maps of the respective support images, Subsequently, the feature map of the query image and the feature maps of the respective support images are respectively paired to be inputted to the refining unit 602, to obtain a matching feature vector representing a matching degree and a matching location between the query image and the respective support image.

According to the embodiment of the present disclosure, the convolutional unit 603 may determine a matching degree and a matching location between the support image and the query image by subjecting the matching feature vector to convolution operations with the feature map of the support image and the feature map of the query image respectively.

For example, as shown in FIG. 7, both the query image and the first support image display an orange. The image processing apparatus 600 may recognize that the two images display a common object, i.e., an orange, and present locations of the object in the query image and the first support image in highlighted manner.

As can be seen, the image processing apparatus according to the embodiment of the present disclosure is capable of determining a matching support image among a plurality of support images respectively belonging to different classes which matches a query image, and determining a matching location of the query image with the matching support image.

Further, for the remaining support images which do not match the query image, the image processing apparatus 600 is only capable of making respective objects in the remaining support images be displayed in highlighted manner. Since the query image does not include an object which matches the objects in the remaining support images, processing results about the query image are images which are all black.

As can be seen, even if the inputted query image does not match any support image, the image processing apparatus according to the embodiment of the present disclosure is still capable of giving corresponding processing results; for example, results of the convolution operations by the convolutional unit 603 with respect to the query image are all images which are all black. Therefore, the image processing apparatus according to the embodiment of the present disclosure is capable of handling a case where the query image does not match any support image.

Further, in FIG. 7, a number of refining units which corresponds to a number of classes of image data is shown for the sake of convenience of description. However, those skilled in the art should appreciate that, the number of the refining units is not particularly limited, and one refining unit may be used for all the classes of the image data, to compare the query image with the support images one by one in time multiplexing manner. Further, to increase a classification speed, a plurality of refining units, each of which corresponds to one or more classes of the image data, may be used.

Accordingly, the present disclosure further proposes a training method for training an image processing apparatus.

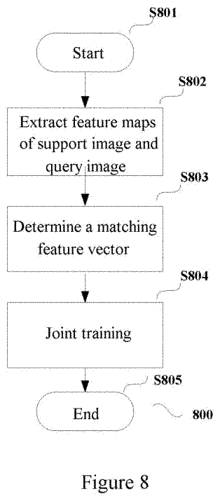

FIG. 8 is a flowchart showing a training method 800 for training an image processing apparatus according to an embodiment of the present disclosure.

The training method 800 starts at step S801. Subsequently, in step S802, a feature map of each of a plurality of support images and a feature map of a query image are extracted. In some embodiments, the processing in step S802 may be implemented by the feature map extracting unit 101 described above with reference to FIGS. 1 to 5.

Subsequently, in step S803, with respect to each support image, a matching feature vector representing a matching degree and a matching location between the support image and the query image are determined, through N times of iterative calculation, based on the feature maps of the support image and the query image, where N is a natural number not less than 2. In some embodiments, the processing in step S803 may be implemented by the refining unit 102 described above with reference to FIGS. 1 to 5.

Subsequently, in step S804, each of a plurality of training images is used as the query image to execute joint training on parameters used in the step S802 and parameters used in the step S803 based on the matching feature vector, wherein each of the plurality of training images matches a specific support image among the plurality of support images. In some embodiments, the processing in step S804 may be implemented by the joint training unit 103 described above with reference to FIGS. 1 to 5.

Finally, the training method 800 ends at step S805.

The image processing apparatus trained by the above-mentioned training method is capable of determining a matching support image among a plurality of support images respectively belonging to different classes which matches a query image, and determining a matching location of the query image with the matching support image. Further, the image processing apparatus is also capable of handling a case where the query image does not match any support image.

Although the embodiments of the present disclosure have been described above by taking image data as an example, it would be obvious for those skilled in the art that, the embodiments of the present disclosure can also be applied to other few-shot precise classification fields, such as speech data, text data and the like.

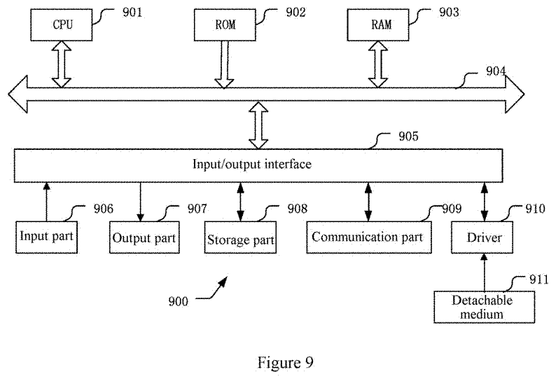

FIG. 9 is a structure diagram showing a general-purpose machine 900 that can be used to realize the training apparatus and training method according to the embodiments of the present disclosure. The general-purpose machine 900 may be, for example, a computer system. It should be noted that, the general-purpose machine 900 is only an example, but does not suggest a limitation to a use range or function of the training method and training apparatus according to the present disclosure. Also, the general-purpose machine 900 should not be construed as having a dependency or demand for any assembly or a combination thereof as shown in the above-mentioned training apparatus or training method.

In FIG. 9, a Central Processing Unit (CPU) 901 executes various processing according to programs stored in a Read-Only Memory (ROM) 902 or programs loaded from a storage part 908 to a Random Access Memory (RAM) 903. In the RAM 903, data needed when the CPU 901 executes various processing and the like is also stored according to requirements. The CPU 901, the ROM 902 and the RAM 903 are connected to each other via a bus 909. An input/output interface 905 is also connected to the bus 904.

The following components are also connected to the input/output interface 905: an input part 906, including a keyboard, a mouse and the like; an output part 907, including a display, such as a Cathode Ray Tube (CRT), a Liquid Crystal Display (LCD) and the like, as well as a speaker and the like; the storage part 908, including a hard disc and the like; and a communication part 909, including a network interface card such as an LAN card, a modem and the like. The communication part 909 executes communication processing via a network such as the Internet. According to requirements, a driver 910 may also be connected to the input/output interface 905. A detachable medium 911 such as a magnetic disc, an optical disc, a magnetic optical disc, a semiconductor memory and the like is installed on the driver 910 according to requirements, such that computer programs read therefrom may be installed in the storage part 908 according to requirements.

In a case where the foregoing series of processing is implemented by software, a program constituting the software may be installed from a network such as the Internet or a storage medium such as the detachable medium 911.

Those skilled in the art should understand that, such a storage medium is not limited to the detachable medium 911 in which a program is stored and which is distributed separately from an apparatus to provide the program to a user as shown in FIG. 9. Examples of the detachable medium 911 include a magnetic disc (including a floppy disc), a compact disc (including a Compact Disc Read-Only Memory (CD-ROM) and a Digital Versatile Disc (DVD)), a magneto optical disc (including a Mini Disc (MD) (registered trademark)), and a semiconductor memory. Alternatively, the memory medium may be hard discs included in the ROM 902 and the memory part 908 and the like, in which programs are stored and which are distributed together with the apparatus containing them to a user.

Further, the present disclosure also proposes a program product having stored thereon a machine readable instruction code that, when read and executed by a machine, can implement the above-mentioned training method according to the present disclosure. Accordingly, the above-listed various storage media for carrying such a program product are also included within the scope of the present disclosure.

Detailed description has been made above by means of block diagrams, flowcharts and/or embodiments, setting forth the detailed embodiments of the apparatuses and/or method according to the embodiments of the present disclosure. When these block diagrams, flowcharts and/or embodiments include one or more functions and/or operations, those skilled in the art would appreciate that the respective functions and/or operations in these block diagrams, flowcharts and/or embodiments could be separately and/or jointly implemented by means of various hardware, software, firmware or any substantive combination thereof. In one embodiment, several portions of the subject matter described in the present specification could be implemented by an Application Specific Integrated Circuit (ASIC), a Field Programmable Gate Array (FPGA), a Digital Signal Processor (DSP) or other integrated forms. However, those skilled in the art would recognize that, some aspects of the embodiments described in the present specification could be equivalently implemented wholly or partially in the form of one or more computer programs running on one or more computers (e.g., in the form of one or more computer programs running on one or more computer systems), in the form of one or more programs running on one or more processors (e.g., in the form of one or more programs running on one or more micro-processors), in the form of firmware, or in the form of any substantive combination thereof; moreover, according to the contents of the disclosure in the present specification, designing circuitry for the present disclosure and/or writing a code for the software and/or firmware of the present disclosure are completely within the ability of those skilled in the art.

It should be emphasized that, the term “comprise/include” used herein refers to presence of features, elements, steps or assemblies, but does not preclude presence or addition of one or more other features, elements, steps or assemblies. The terms “first”, “second” and the like relating to ordinal numbers do not represent implementation orders or importance degrees of the features, elements, steps or assemblies defined by these terms, but are only used for performing identification among these features, elements, steps or assemblies for the sake of clarity of description.

In conclusion, in the embodiments of the present disclosure, the present disclosure provides the following solutions, but is not limited hereto:

Solution 1. A training apparatus for training an image processing apparatus, the image processing apparatus used for determining a matching support image among a plurality of support images respectively belonging to different classes which matches a query image and for determining a matching location of the query image with the matching support image, the training apparatus comprising:

a feature map extracting unit configured to extract a feature map of each of the plurality of support images and a feature map of the query image;

a refining unit configured to determine, with respect to each support image, a matching feature vector representing a matching degree and a matching location between the support image and the query image, through N times of iterative calculations, based on the feature maps of the support image and the query image, where N is a natural number not less than 2; and

a joint training unit configured to use each of a plurality of training images as the query image to execute joint training on parameters of the feature map extracting unit and parameters of the refining unit based on the matching feature vector, such that the image processing apparatus is capable of determining the matching support image and the matching location with respect to a new query image, wherein each of the plurality of training images matches a specific support image among the plurality of support images.

Solution 2. The training apparatus according to Solution 1, wherein each class of the plurality of support images has one or more support images.

Solution 3. The training apparatus according to Solution 1 or 2, wherein the feature map extracting unit is realized through a convolutional neural network.

Solution 4. The training apparatus according to any one of Solutions 1 to 3, wherein the refining unit further comprises:

a feature vector extracting sub-unit configured to extract feature vectors of the support image and the query image based on the feature maps of the support image and the query image;

a similarity degree calculating sub-unit configured to calculate a similarity degree between the feature vector of the support image and the feature vector of the query image; and

a cyclic updating sub-unit configured to calculate the matching feature vector based on the feature vectors of the support image and the query image and the similarity degree.

Solution 5. The training apparatus according to Solution 4, wherein the feature vector extracting sub-unit is further configured to:

for a first time of iterative calculation, extract the feature vectors of the support image and the query image through global average pooling based on the feature maps of the support image and the query image; and

for an n-th time of iterative calculation, extract the feature vectors of the support image and the query image through global average pooling based on the feature maps of the support image and the query image and the matching feature vector obtained through an (n−1)-th time of iterative calculation, where n is a natural number greater than 1 and less than or equal to N.

Solution 6. The training apparatus according to Solution 4, wherein the similarity degree calculating sub-unit is realized through a multi-layer perceptron.

Solution 7. The training apparatus according to Solution 4, wherein the cyclic updating sub-unit is further configured to:

for a first time of iterative calculation, calculate the matching feature vector based on the feature vectors of the support image and the query image and the similarity degree; and

for an n-th time of iterative calculation, calculate the matching feature vector based on the feature vectors of the support image and the query image, the similarity degree and the matching feature vector obtained through an (n−1)-th time of iterative calculation, where n is a natural number greater than 1 and less than or equal to N.

Solution 8. The training apparatus according to Solution 4, wherein the cyclic updating sub-unit is realized through a simplified long short-term memory model of an outgate operation.

Solution 9. The training apparatus according to any one of Solutions 1 to 8, wherein the joint training unit is further configured to perform joint training on parameters of the convolutional neural network which realizes the feature map extracting unit, the multi-layer perceptron which realizes the similarity degree calculating sub-unit and the simplified long short-term memory model which realizes the cyclic updating sub-unit.

Solution 10. A training method for training an image processing apparatus, the image processing apparatus used for determining a matching support image among a plurality of support images respectively belonging to different classes which matches a query image and for determining a matching location of the query image with the matching support image, the training method comprising:

extracting a feature map of each of the plurality of support images and a feature map of the query image;

determining, with respect to each support image, a matching feature vector representing a matching degree and a matching location between the support image and the query image, through N times of iterative calculations, based on the feature maps of the support image and the query image, where N is a natural number larger than 2; and

using each of a plurality of training images as the query image to execute joint training on parameters of a feature map extracting unit and parameters of a refining unit based on the matching feature vector, such that the image processing apparatus is capable of determining the matching support image and the matching location with respect to a new query image, wherein each of the plurality of training images matches a specific support image among the plurality of support images.

Solution 11. The training method according to Solution 10, wherein each class of the plurality of support images has one or more support images.

Solution 12. The training method according to Solution 10 or 11, wherein the step of extracting the feature map is implemented through a convolutional neural network.

Solution 13. The training method according to any one of Solutions 10 to 12, wherein the step of determining the matching feature vector further comprises:

extracting feature vectors of the support image and the query image based on the feature maps of the support image and the query image;

calculating a similarity degree between the feature vector of the support image and the feature vector of the query image; and

calculating the matching feature vector based on the feature vectors of the support image and the query image and the similarity degree.

Solution 14. The training method according to Solution 13, wherein the step of extracting the feature vectors further comprises:

for a first time of iterative calculation, extract the feature vectors of the support image and the query image through global average pooling based on the feature maps of the support image and the query image; and

for an n-th time of iterative calculation, extract the feature vectors of the support image and the query image through global average pooling based on the feature maps of the support image and the query image and the matching feature vector obtained through an (n−1)-th time of iterative calculation, where n is a natural number greater than 1 and less than or equal to N.

Solution 15. The training method according to Solution 13, wherein the step of calculating the similarity degree is implemented through a multi-layer perceptron.

Solution 16. The training method according to Solution 13, wherein the step of calculating the matching feature vector further comprises:

for a first time of iterative calculation, calculating the matching feature vector based on the feature vectors of the support image and the query image and the similarity degree; and

for an n-th time of iterative calculation, calculating the matching feature vector based on the feature vectors of the support image and the query image, the similarity degree and matching feature vector obtained through an (n−1)-th time of iterative calculation, where n is a natural number greater than 1 and less than or equal to N.

Solution 17. The training method according to Solution 13, wherein the step of calculating the matching feature vector is implemented through a simplified long short-term memory model of an outgate operation.

Solution 18. The training method according to any one of Solutions 10 to 17, wherein the step of performing the joint training performs joint training on parameters of the convolutional neural network which implements the step of extracting the feature map, the multi-layer perceptron which implements the step of calculating the similarity degree and the simplified long short-term memory model which implements the step of calculating the matching feature vector.

Solution 19: An image processing apparatus, for determining a matching support image among a plurality of support images respectively belonging to different classes which matches a query image and for determining a matching location of the query image with the matching support image, the image processing apparatus obtained by performing training through the training apparatus according to any one of Solutions 1 to 9, the image processing apparatus comprising:

the feature map extracting unit;

the refining unit; and

a convolutional unit configured to execute a convolution operation of the matching feature vector and the feature map of the support image and a convolution operation of the matching feature vector and the query image.

Solution 20: A computer readable storage medium having stored thereon a computer program that, when executed, causes a computer to perform the processing of:

extracting a feature map of each of the plurality of support images and a feature map of the query image;

determining, with respect to each support image, a matching feature vector representing a matching degree and a matching location between the support image and the query image, through N times of iterative calculations, based on the feature maps of the support image and the query image, where N is a natural number not less than 2; and

using each of a plurality of training images as the query image to execute joint training on parameters of a feature map extracting unit and parameters of a refining unit based on the matching feature vector, such that the image processing apparatus is capable of determining the matching support image and the matching location with respect to a new query image, wherein each of the plurality of training images matches a specific support image among the plurality of support images.

Although the present disclosure has been disclosed above by describing the detailed embodiments of the present disclosure, it should be understood that those skilled in the art could carry out various modifications, improvements or equivalents for the present disclosure within the spirit and scope of the appended claims. Such modifications, improvements or equivalents should also be regarded as being included within the scope of protection of the present disclosure.

1. A training apparatus for training an image processing apparatus, the image processing apparatus used for determining a matching support image among a plurality of support images respectively belonging to different classes which matches a query image and for determining a matching location of the query image with the matching support image, the training apparatus comprising:
a feature map extracting unit configured to extract a feature map of each of the plurality of support images and a feature map of the query image;
a refining unit configured to determine, with respect to each support image, a matching feature vector representing a matching degree and a matching location between the support image and the query image, through N times of iterative calculations, based on the feature maps of the support image and the query image, where N is a natural number not less than 2; and
a joint training unit configured to use each of a plurality of training images as the query image to execute joint training on parameters of the feature map extracting unit and parameters of the refining unit based on the matching feature vector, such that the image processing apparatus is capable of determining the matching support image and the matching location with respect to a new query image, wherein each of the plurality of training images matches a specific support image among the plurality of support images.

2. The training apparatus according to claim 1, wherein the feature map extracting unit is realized through a convolutional neural network.

3. The training apparatus according to claim 1, wherein the refining unit further comprises:
a feature vector extracting sub-unit configured to extract feature vectors of the support image and the query image based on the feature maps of the support image and the query image;
a similarity degree calculating sub-unit configured to calculate a similarity degree between the feature vector of the support image and the feature vector of the query image; and
a cyclic updating sub-unit configured to calculate the matching feature vector based on the feature vectors of the support image and the query image and the similarity degree.

4. The training apparatus according to claim 3, wherein the feature vector extracting sub-unit is further configured to:
for a first time of iterative calculation, extract the feature vectors of the support image and the query image through global average pooling based on the feature maps of the support image and the query image; and
for an n-th time of iterative calculation, extract the feature vectors of the support image and the query image through global average pooling based on the feature maps of the support image and the query image and the matching feature vector obtained through an (n−1)-th time of iterative calculation, where n is a natural number greater than 1 and less than or equal to N.

5. The training apparatus according to claim 3, wherein the similarity degree calculating sub-unit is realized through a multi-layer perceptron.

6. The training apparatus according to claim 3, wherein the cyclic updating sub-unit is further configured to:
for a first time of iterative calculation, calculate the matching feature vector based on the feature vectors of the support image and the query image and the similarity degree; and
for an n-th time of iterative calculation, calculate the matching feature vector based on the feature vectors of the support image and the query image, the similarity degree and the matching feature vector obtained through an (n−1)-th time of iterative calculation, where n is a natural number greater than 1 and less than or equal to N.

7. The training apparatus according to claim 3, wherein the cyclic updating sub-unit is realized through a simplified long short-term memory model of an outgate operation.

8. The training apparatus according to claim 3, wherein the joint training unit is further configured to perform joint training on parameters of the convolutional neural network that realizes the feature map extracting unit, the multi-layer perceptron that realizes the similarity degree calculating sub-unit and the simplified long short-term memory model that realizes the cyclic updating sub-unit.

9. The training apparatus according to claim 1, wherein each class of the plurality of support images has one or more support images.

10. A training method for training an image processing apparatus, the image processing apparatus used for determining a matching support image among a plurality of support images respectively belonging to different classes which matches a query image and for determining a matching location of the query image with the matching support image, the training method comprising:
extracting a feature map of each of the plurality of support images and a feature map of the query image;
determining, with respect to each support image, a matching feature vector representing a matching degree and a matching location between the support image and the query image, through N times of iterative calculations, based on the feature maps of the support image and the query image, where N is a natural number not less than 2; and
using each of a plurality of training images as the query image to execute joint training on parameters used in the step of extracting the feature map and parameters used in the step of determining the matching feature vector based on the matching feature vector, such that the image processing apparatus is capable of determining the matching support image and the matching location with respect to a new query image, wherein each of the plurality of training images matches a specific support image among the plurality of support images.

11. The training method according to claim 10, wherein each class of the plurality of support images has one or more support images.

12. The training method according to claim 10, wherein the step of extracting the feature map is implemented through a convolutional neural network.

13. The training method according to claim 10, wherein the step of determining the matching feature vector further comprises:
extracting feature vectors of the support image and the query image based on the feature maps of the support image and the query image;
calculating a similarity degree between the feature vector of the support image and the feature vector of the query image; and
calculating the matching feature vector based on the feature vectors of the support image and the query image and the similarity degree.

14. The training method according to claim 13, wherein the step of extracting the feature vectors further comprises:
for a first time of iterative calculation, extract the feature vectors of the support image and the query image through global average pooling based on the feature maps of the support image and the query image; and
for an n-th time of iterative calculation, extract the feature vectors of the support image and the query image through global average pooling based on the feature maps of the support image and the query image and the matching feature vector obtained through an (n−1)-th time of iterative calculation, where n is a natural number greater than 1 and less than or equal to N.

15. The training method according to claim 13, wherein the step of calculating the similarity degree is implemented through a multi-layer perceptron.

16. The training method according to claim 13, wherein the step of calculating the matching feature vector further comprises:
for a first time of iterative calculation, calculating the matching feature vector based on the feature vectors of the support image and the query image and the similarity degree; and
for an n-th time of iterative calculation, calculating the matching feature vector based on the feature vectors of the support image and the query image, the similarity degree and matching feature vector obtained through an (n−1)-th time of iterative calculation, where n is a natural number greater than 1 and less than or equal to N.

17. The training method according to claim 13, wherein the step of calculating the matching feature vector is implemented through a simplified long short-term memory model of an outgate operation.

18. The training method according to claim 13, wherein the step of performing the joint training performs joint training on parameters of the convolutional neural network which implements the step of extracting the feature map, the multi-layer perceptron which implements the step of calculating the similarity degree and the simplified long short-term memory model which implements the step of calculating the matching feature vector.

19. An image processing apparatus, for determining a matching support image among a plurality of support images respectively belonging to different classes which matches a query image and for determining a matching location of the query image with the matching support image, the image processing apparatus obtained by performing training through the training apparatus according to claim 1, the image processing apparatus comprising:
the feature map extracting unit;
the refining unit; and
a convolutional unit configured to execute a convolution operation of the matching feature vector and the feature map of the support image and a convolution operation of the matching feature vector and the query image.
